(19) United States
(12) Patent Application Publication
(10) Pub. No.: US 2008/0147364 A1
(43) Pub. Date: Jun. 19, 2008

(54) METHOD AND APPARATUS FOR GENERATING HAREL STATECHARTS USING FORMS SPECIFICATIONS

(75) Inventors: Paul C. Davis, Chicago, IL (US); William K. Thompson, Evanston, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/611,288

(22) Filed: Dec. 15, 2006

(51) Int. Cl. G06G 7/48

(52) U.S. Cl. 703/6

(57) ABSTRACT

A method and apparatus for generating an extended Harel Statechart for an automated interaction from a declarative interaction specification. The declarative interaction specification includes a model of interaction data and a set of controls. A set of states are generated in the extended Harel Statechart corresponding to the set of controls of the interaction specification and self-transitions, which include actions associated with the state, are generated for each state. A data model associated with the set of states is also generated in the extended Harel Statechart from the model of interaction data. Transitions between states are also generated to correspond to changes in control activation.

### CROSS REFERENCES TO RELATED APPLICATIONS

This application is related to U.S. patent application Ser. No. 11/421,012, filed May 30, 2006 and titled “State Chart Generation Using Frames”, and to U.S. patent application Ser. No. 11/420,995, filed May 30, 2006 and titled Hierarchical State Machine Generation for Interaction Management Using Goal Specifications. These applications and the instant application are commonly owned.

### FIELD OF THE INVENTION

The present invention relates generally to automated interaction management.

### BACKGROUND

Recent years have seen a large increase in the amount of content available over the Internet, as well as a proliferation of electronic devices, offering ever more features and functionality. Consequently, there is a large and growing demand for tools that support interface design and implementation. Part of this demand has been addressed through the development of formalized interaction control languages, resulting in the creation of standard specifications in this area (such as Call Control eXtensible Markup Language (CCXML), VoiceXML, XForms, and State Chart eXtensible Markup Language (SCXML) from the World Wide Web Consortium (W3C)).

One popular technique for specifying abstract interaction control logic is to use finite state machine (FSM) languages, which explicitly enumerate the various states and transitions in an interaction flow. This technique is embodied in the W3C CCXML specification. FSM languages like CCXML provide developers with a relatively simple technique for specifying interaction control logic with well-understood run-time semantics. However, FSMs can be difficult to develop and maintain when interfaces are very large, due to rapid growth in the number of states and transitions required to model such interfaces. Consequently, recent proposals have been made to use Harel Statecharts as a generic control language for specifying user interaction control logic. Harel Statecharts are also known as Hierarchical State Machines (HSMs) and the acronym HSM will be used in sequel to refer to a Harel Statechart. The use of HSMs for interaction control has recently been embodied in the W3C SCXML specification [5], which is intended as a generalization of and replacement for CCXML. HSMs are similar to FSMs, but they are augmented with a variety of additional constructs, including hierarchical states, guard conditions, and parallel states. These added constructs can make HSMs simpler and more extensible than equivalent FSMs, primarily because they factor out common behavior into common super-states, eliminating duplication of logic, and reducing the number of states and transitions required to model a set of interaction flows.

Though HSMs are a definite improvement over FSMs, they are still quite limited in some respects. HSMs do not directly provide the means for expressing commonly used higher-level abstractions for expressing interaction control logic, such as forms and menus, which don't contain a direct representation of states and transitions. These constructs (used in such W3C standards as Hypertext Markup Language (HTML), VoiceXML and XForms) are simple and powerful means for expressing a very common style of interaction. In a form-based interaction, the system requires certain pieces of information from the user in order to accomplish some domain specific task (such as booking a flight, finding a restaurant, or finding out who you want to call on the phone). Once all of the required data has been collected from the user, the system can achieve the task it is designed to perform. A menu is a specific kind of form where only one piece of information (chose from a set of alternatives) needs to be provided. These kinds of interactions occur repeatedly in interactive systems, including device-based interfaces as well as web-based applications. A primary advantage of such form-based techniques over finite-state scripts is that they enable an interaction designer to create a relatively complex interaction or subpart of an interaction in a relatively compact representation. A form succinctly represents a large number of states by eliminating much of the explicit process logic that is required in FSMs and HSMs. Although forms by themselves typically do not model an entire interaction system, they are often at the core of the interaction task being modeled.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example form specification.

FIG. 2 is an exemplary presentation of the form specification of FIG. 1.

FIG. 3 is a schematic representation of a mapping procedure in accordance with some embodiments of the invention.

FIG. 4 is a schematic representation of interaction management using a Harel Statechart in accordance with some embodiments of the invention.

FIG. 5 is a schematic representation of state self-transitions in a Harel Statechart in accordance with some embodiments of the invention.

FIG. 6 is a further schematic representation of a state transition in a Harel Statechart in accordance with some embodiments of the invention.

FIG. 7 is a schematic representation of an exemplary extended Harel Statechart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the generation of Harel Statecharts using form specifications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of Harel Statechart generation described herein. The non-processor circuits may include, but are not limited to, signal drivers, clock circuits, power source circuits, audio inputs and outputs, visual outputs and user input devices. As such, these functions may be interpreted as a method to generate Harel Statecharts using form specifications. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

One embodiment of the invention relates to a method and apparatus for generating an extended Harel Statechart for an automated interaction from a declarative interaction specification that includes a model of interaction data and a set of controls. An extended Harel Statechart is the combination of a Harel Statechart and an associated data model. The declarative interaction specification may be, for example, an Xforms specification. A set of states are generated in the extended Harel Statechart corresponding to the set of controls of the interaction specification. Self-transitions, which include actions associated with the state, are generated to each state. A data model associated with the set of states is also generated in the extended Harel Statechart from the model of interaction data. Transitions may also be generated between states to correspond to activation of different controls.

The method may be performed by a computer or processor that is operable to read a computer readable medium, such as a memory or disc, containing programming instructions. When executed, the instructions control the processor to generate an extended Harel Statechart for an automated interaction from a declarative interaction specification comprising a model of interaction data and a set of controls. The programming instructions include:

a MAP-CONTROLS function that is operable to generate a set of states in the extended Harel Statechart corresponding to the set of controls of the interaction specification, and is further operable to generate self transitions to each state of the set of states, and

a MAP-MODEL function, operable to generate a data model in the extended Harel Statechart from the model of interaction data. The data model is associated with the set of states and the self-transitions include actions associated with the state.

The declarative interaction specification may also include model properties in which case the programming instructions may also include a MAP-PROPERTIES function that is operable to generate a set of data model actions from the properties of declarative interaction specification, the data model actions to be evaluated when the data model is updated.

The declarative interaction specification may also include indications of which forms may be active at a given time, in which case programming instructions may include a MAP-ACTIVATION function that is operable to generate a set of transitions between states in the HSM corresponding to controls as well as exit and entry conditions on the states.

Although forms by themselves typically do not model an entire interaction system, they are often at the core of the interaction task being modeled. There are a number of different languages that may be used to specify a form. Some form specification languages explicitly separate of form data from form control. One example is XForms, which is a currently evolving standard. Xforms is a leading instantiation of a form-based interaction language, imposing strict separation of data from control. This separation has several clear advantages. Firstly, it makes it easier to maintain, model, and generalize forms over their lifetime. Secondly, it makes it much easier to use the same control logic with multiple modalities, either in isolation or concurrently. Thirdly, it makes it possible to extend forms with new kinds of form controls. XForms, for example, provides several built-in types of form controls, and makes it possible for interface designers to extend this set with controls of their own invention.

Various embodiments of the invention are described below in terms of XForms. However, the invention may use other form specifications that separate data from control.

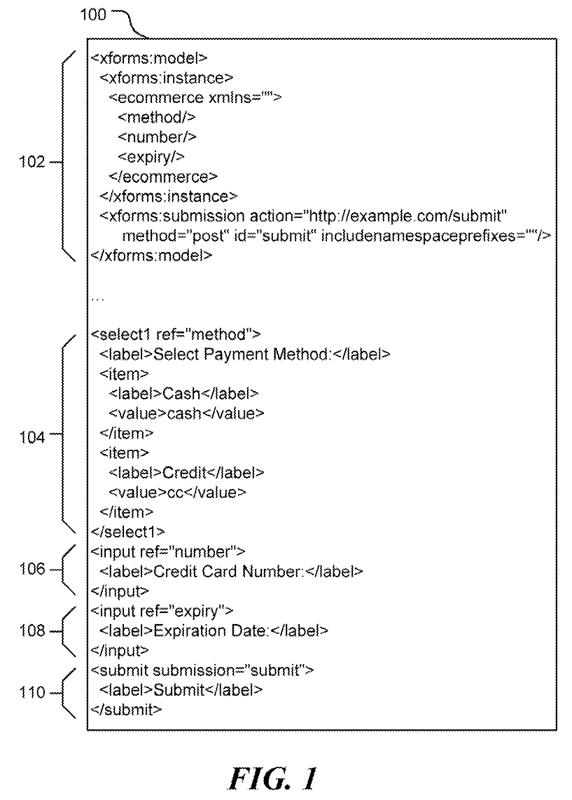

An example of an XForms specification of a form, illustrating separation of data (an XForms model) from control, is shown in FIG. 1. The form specification 100 includes a model description 102, a user selection control 104, input controls 106 and 108 and a submission or action control 110. The specification does not define how the form is to be presented to a user. The Xforms specification may be embedded in another markup language document.

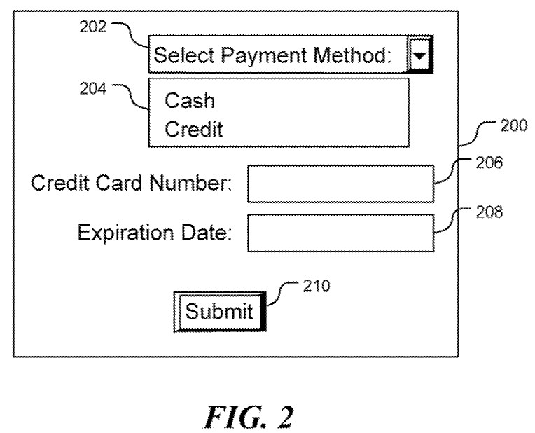

FIG. 2 is an exemplary presentation of the form specification of FIG. 1. The presentation 200 include a selection control 202 (corresponding to control 104 in FIG. 1). The selection control 202 displays a menu of items 204 when the control 202 is selected by a user. Text input boxes 206 and 208 with appropriates labels are presented corresponding to the input controls 106 and 108 in FIG. 1. Finally, a submission button 210 is presented corresponding to the submission control 110 in FIG. 1. In this example the presentation is visual, and the user may user a computer mouse and/or keyboard to provide input. However, the presentation could be an audio presentation in which an audio prompt is used and the user's voice is sensed to provide input, or other type of interface.

Despite its strengths, abstract declarative languages like XForms are not the complete solution to all interaction design problems. The XForms language (as well as other, similar abstract declarative languages) suffers from a number of weaknesses. Firstly, the interaction designer may desire more fine-grained control of the interaction than a specification such as XForms provides. Secondly, beyond embedding XForms specifications in other markup, there is no clear means for combining them with other interaction description types. This may be required in order to implement non-form-based interactions. Thirdly, it can be hard to verify and debug a form specification, since the run-time behavior of abstract, declarative forms can be difficult to visualize.

The present invention preserves the advantages of using the XForms language (or a similar language) while addressing these weaknesses. In some embodiments of the invention this is achieved by providing a mapping from abstract declarative form specifications (with separate data and control) to extended Harel Statecharts (HSM's). The term ‘extended HSM’ is abbreviated to HSM in the sequel.

The mapping from form to HSM provides the designer with more fine-grained control over interaction logic (by allowing the designer to edit the resulting HSM). Further, the mapping permits specifications such as XForms to be combined with other types of interaction abstractions either specified directly as HSM's or themselves compiled from higher-level abstractions. In this paradigm, HSM's serve as a kind of “assembly language” for interaction control specifications. Still further, the mapping to an HSM makes it easier to verify and debug run-time behavior, because the HSM provides a natural way to visualize an evolving interaction with a user.

In one embodiment of the invention, abstract declarative interaction specifications, such as XForms, with separable data and control are mapped into equivalent extended Harel Statecharts (extended HSMs). More specifically, the form controls of an XForms specification are mapped directly into HSM states, and these states are composed together in order to capture the intended behaviors of the source XForm specification. The mapping from XForms to HSM's creates semantic representation of XForms as HSM's. This mapping provides a means for seamlessly combining XForms (and constructs from similar languages) with any other control specification that can be mapped to HSM's, such as VoiceXML, or with control logic specified directly as an HSM.

Interaction designers can use XForms constructs (abstractions), such as form controls, to generate HSM's and HSM components (sets of states and transitions). Form controls are the markup used in XForms in order to collect and display information related to an XForms model. These abstractions are quite powerful, encompassing much more than traditional form-like constructs such as forms and menus. They include notions such as secret inputs (secret element), unrestricted input (input element), output display (output element), etc. It is also possible for form designers to extend the existing set of form controls by creating their own. Such constructs simplify the interface design process, since notions such as “select one of the options” and “fill in all the slots” need not be manually entered but can be automatically generated from a pre-existing abstraction.

XForms enforces a clean separation between data and control. The presentation and manipulation of a form is accomplished through the mechanism of form controls, while the form data is stored in an XForms model. Additionally, XForms model item properties can be used to enforce constraints on the XForms model, as well as perform automatic updates of data model fields based on the current state of other fields. Form controls and model item properties are related to the model by the use of binding expressions, which refer (using XPath) to a portion of the data model instance. A “binding” connects an instance data node to a form control or to a model item constraint by using a binding expression as a locater. The mapping from Xforms to HSM preserves the XForms separation of the data model from the form controls. A set of HSM states (and state transitions) is generated from the form controls. A set of data model actions will be generated from the model item properties, and these actions will be directly associated with the data model.

This process is described as a set of mappings from XForm constructs into extended Statechart constructs. The following definitions are used:

A Statechart consists of a tuple (S, T, A), where S is a set of states, T is a set of transitions, and A is a set of actions. An Extended Statechart is a Statechart with an associated data model.

A form consists of a tuple (m, P, C), where m is a model, P is a (possibly empty) set of model properties, and C is a set of controls.

A property is a tuple (b, Act), where b is a binding expression to the model, and Act is a set of actions that will be executed whenever an attempt is made to modify the portion of the model referred to by b.

A control is a tuple (t, Var), where t is a type and Var is a set of variables. The type t of the control gives an abstract characterization of how it works (e.g., select, range, input, output). The set of variables Var is used to model various attributes of the control (e.g., storing values for the control's binding expression, its label, and its unique id). The complete set of variables for a control depends in part on the control's type (e.g., range controls have variables for start and end points, but input controls do not). Some variables will be immutable (e.g., the control's binding expression) and may be treated as constants.

A policy is defined as a partition of controls into (possibly overlapping) subsets Sᵢ, along with a mapping from (Sᵢ, e) to Sⱼ, derived from a host document. This mapping takes a beginning set Sᵢ of controls and a transition event e, and returns another set of controls Sⱼ. XForms are not intended to serve as stand-alone documents, and policies are supplied by the host language inside of which an XForm is embedded. It is the host language that decides what sets of form controls are active (an active control is one that is presented or available to a user for update or focus at any given point in time), and how to transition to other sets of form controls. The techniques for accomplishing this differ, for example, depending on whether an XForm is embedded in an XHTML document that needs to be rendered graphically, or in a VoiceXML document that defines a speech dialogue.

A trigger is defined here as a special type of control that has no binding expression.

A user interface element is defined here as a control with complex content, i.e., it groups together other controls into a single (complex) control.

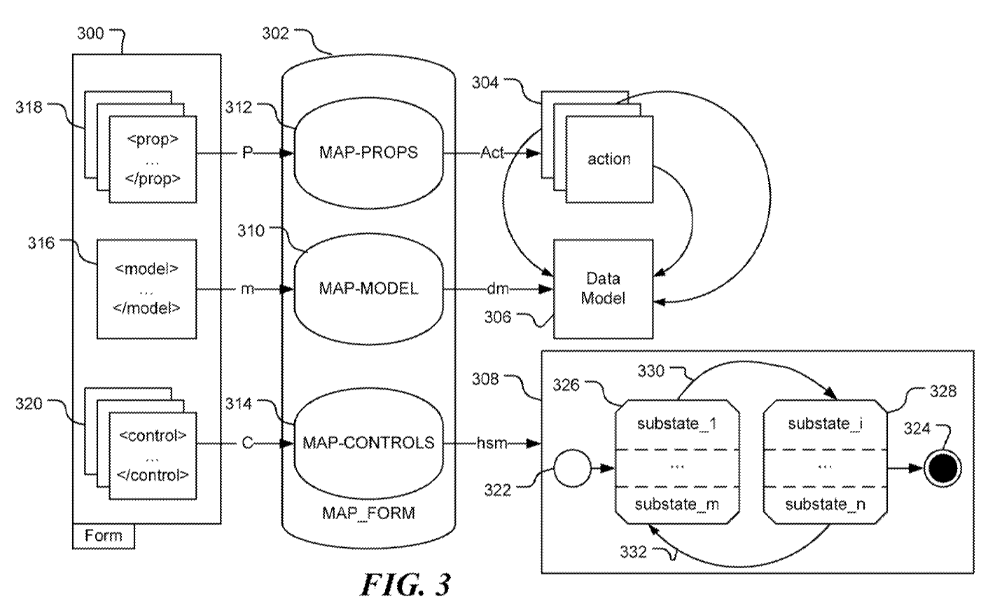

FIG. 3 is a schematic representation of a mapping procedure in accordance with some embodiments of the invention. The procedure takes a form 300, processes it using a mapping function 302 and produces a set of actions 304, a data model 306 and a Harel statechart (HSM) 308. Five mapping functions are used, namely MAP-FORM 302, MAP-MODEL 310, MAP-PROPS 312, MAP-CONTROLS 314, and MAP-ACTIVATION.

The mapping function MAP-FORM 302 takes as inputs a form f (300) consisting of a tuple (m, P, C), and a policy pol, where m is a model 316, P is a (possibly empty) set of model properties 318, and C is a set of controls 320. The mapping function MAP-FORM 302 produces, as output, a tuple (dm, Act, hsm), where dm is a data model 306, Act is a set of data model actions 304, and hsm=(States, Trans, Actions) is an HSM 308. The return value is formed by first applying the mapping function MAP-MODEL 310 to m, the mapping function MAP-PROPS to P, and the mapping function MAP-CONTROLS to C. This provides a data model dm, a set of data model actions Act, and a set of HSM states S. The member states of S are then assembled into hsm as follows. Firstly, S is first partitioned into a set of subsets Sᵢ, according to policy pol. Each Sᵢ consists of the set of states that are “active” at any given point in an interaction, as determined by the policy. Secondly, for each Sᵢ, a single parallel state pᵢ is generated in the HSM. Each pᵢ will contain all members of the corresponding Sᵢ as parallel sub-states. The transitions between the pᵢ are also determined by the policy, and generated by the MAP-ACTIVATION function. The top-level topology of the generated HSM therefore consists of a set of states, each one of which contains parallel sub-states (as shown in FIG. 3, for example).

The mapping function MAP-MODEL 310 takes a model m (316) as input and produces a data model dm (306) as output. The mapping preserves the essential structure of the model m. For example, this function could create an isomorphic tree representation of the original model so that all of the binding expressions specified on the properties and controls remain valid for the new data model. The data model may be combined with other sources of data in order to form a larger data structure than is contained in the original model m.

The mapping function MAP-PROPS 312 takes as input a set of properties P (318) and produces as output a set of model interactions Act (304). For each property p of P, a single data model action ‘a’ is created. The original attributes of the property p, including its binding expression, are transferred to the model action a as a set of variables associated with ‘a’. The resultant set of actions is evaluated whenever the data model they are associated with is being updated.

The mapping function MAP-CONTROLS 314 takes as input a set of controls C (320) and produces as output a set of HSM states. Initial state 322 and final state 324 are generated. For each control cᵢ element of C, a HSM state sᵢ is created (326 with sub-states sub-state_1, . . . , sub-state_m, state 328 with sub-states sub-state_i, . . . , sub-state_m, etc.). State sᵢ will be associated with a set of local variables, one for each of the variables in the original cᵢ. Additional book-keeping variables (such as an ID variable) may also be added as needed. For each state sᵢ, a single self-transition is added. This transition will contain all actions associated with the state. These actions are generally of two types: (1) an action for generating an event to notify associated viewers that the part of the data model associated with this state has changed (this may be determined by the state's binding expression variable) and (2) an action for generating an event to update to the data model after a user input event. The part of the data model to be updated is again determined by the state's binding expression variable.

The mapping function MAP-ACTIVATION takes as input the policy of the host language in which the form is embedded, and generates a set of HSM states and transitions. Each of the states generated contains a set of parallel sub-states, generated by application of the MAP-CONTROLS function. Each state generated by the MAP-ACTIVATION function represents the set of currently active control states. Transitions (such as 330 and 332) are generated between activation states, and these transitions are triggered by Activation Change Events.

If the control cᵢ is complex (e.g., if derived from an XForms user interface element, which groups together sets of controls), then the mapping function MAP-CONTROLS will be recursively applied to each member control, and will be added as sub-states of cᵢ.

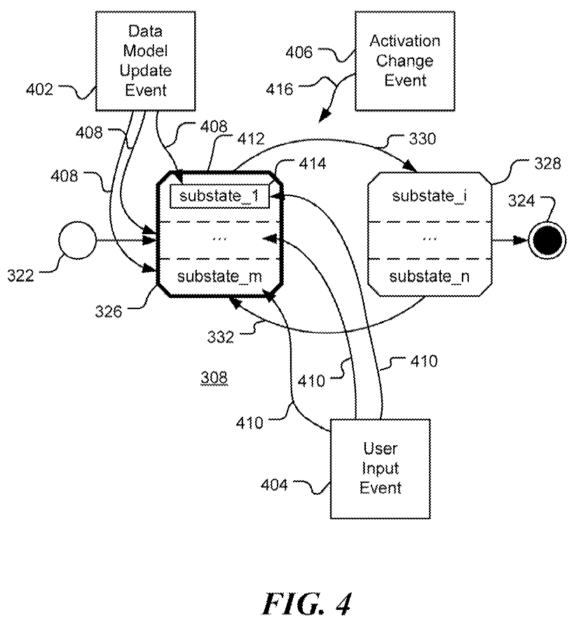

FIG. 4 is a diagrammatic representation of the use of a HSM generated by the mapping function MAP-FORM to control an interaction. Referring to 408, the HSM 308 consumes three (conceptual) types of events: data model update events (402), (2) user input events (404), and activation change events (406).

The payload for a data model update event 402 (that is, the information associated with the event) is the path to sub-part of the data model that was updated. The HSM 308 will receive a data model update event whenever the data model is updated. A copy of this update event will be sent to each parallel sub-state of the currently active state, as depicted by arrows 408 in FIG. 4. This means that when such an event is processed by the HSM, every active “control” state will have the opportunity to check it against its binding expression, and perform any required actions (such as generating a further event for updating associated viewers).

The payload for a user input event 404 is a representation of the user input. The HSM 308 will receive a user input event whenever the user performs an input action. A copy of this update event will be sent to each parallel sub-state of the currently active state, as depicted by the arrows 410 in FIG. 4. However, the only state that will consume this event is the one that is “focused”. The HSM or data model tracks focus in some manner, by storing the ID of the currently focused state in some globally accessible way. An input event can only be processed by the state that has focus—all other states will discard its copy of the user input event. The focused state will accept its copy of the event, take its self-transition, and execute any associated actions as a consequence (such as generating an event that will update the data model with the user's new value). In FIG. 4, the state 412 (and its parallel sub-states) is the active state. The sub-state 414 (sub-state_1) is the focused sub-state.

The payload 416 for an activation change event 406 is the ID of the state receiving focus. As described above with reference to the MAP-FORM mapping function, the top-level topology of the HSM will be a set of states pᵢ, each of which contains the currently active “control” states, which are parallel to one another inside of each of the top-level pᵢ (as shown in FIGS. 3 and 4, for example). The corresponding state 412 in the HSM is called the active state. Activation change events cause the HSM to transition from one active state to another. Changing activation causes a new set of control states to become active.

For the example Xform shown in FIG. 1, the <select1> element is translated into a ‘select1’ control state in the HSM. The elements under select1 (the <item> elements) are stored as variables in the ‘select1’ control state. This may be accomplished by creating a vector of ‘item’ variables, each of which contains its relevant information. One ‘item’ variable will be selected as the “current” one. In operation, when a user update occurs to the ‘select1’ state, the selected information (the selected ‘item’) is packaged in the event that is generated and sent to the associated data model (along with the binding expression information). When a data model update occurs to the ‘select1’ state, the “current” item is updated to reflect the value in the data model.

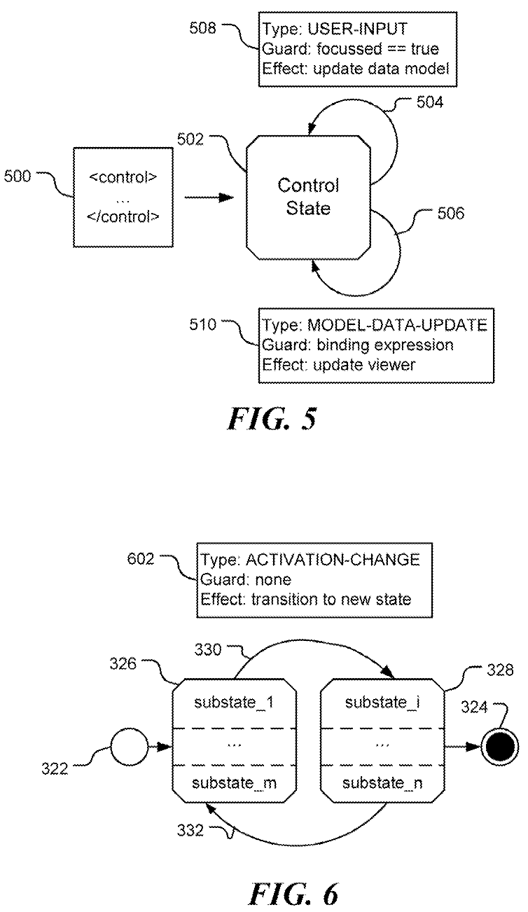

FIG. 5 is a schematic representation of state self-transitions in a Harel Statechart in accordance with some embodiments of the invention. Referring to FIG. 5, the control state 500 has been generated in the statechart in correspondence to a control 502 in an Xforms specification. The control state 500 has two self-transitions, 504 and 506. The self-transition 504 is annotated with an action 508. The action 508 indicates that the self-transition 508 is to be made when a USER-INPUT event is signaled, provided that, as indicated by the guard, the control state 500 is in focus. The effect of the event is to update the element in the associated data model in accordance with the user input. The self-transition 506 is annotated with an action 510. The action 510 indicates that the self-transition 506 is to be made when ever a MODEL-DATA-UPDATE event is signaled, provided that, as indicated by the guard, that the event corresponds to a binding expression. The effect of the event is to update the viewer to show the user the updated data, if appropriate.

FIG. 6 is a further schematic representation of a state transition in a Harel Statechart in accordance with some embodiments of the invention. Referring to FIG. 6, the Statechart has two states, 326 and 328 (in addition to an initial pseudo-state 322 and final state 324). The state transition 330 is annotated with an action 602. The action 602 indicates that the transition 330, from state 326 to state 328, is to be made when a ACTIVATION-CHANGE event is signaled. The effect of the event is to transition to the new state, 328.

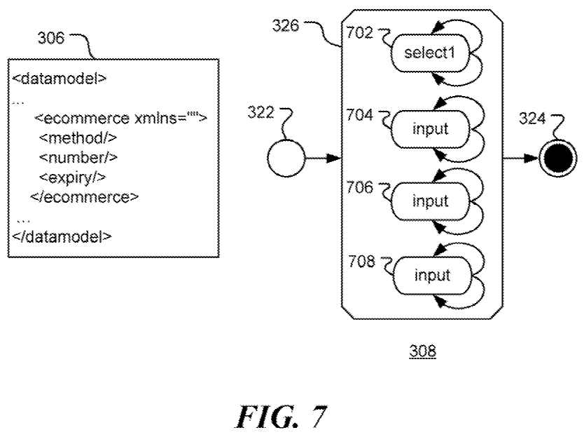

FIG. 7 is a schematic representation of an exemplary extended Harel Statechart in accordance with some embodiments of the invention. The extended Harel Statechart corresponds to the XForms specification shown in FIG. 1 and comprises a data model 306 and a Harel Statechart 308. The data model 306 is generated from the model of interaction data using a MAP-MODEL function. The Harel Statechart 308 is generated from the set of controls of the interaction specification using a MAP-CONTROLS function, and comprises a set of states 702, 704, 706 and 708 corresponding to the controls of the interaction model. Self transitions to each state are also generated, along with an initial pseudo-state 322 and a final state 324.

The extended Harel Statechart generated from the declarative interaction specification may be stored in a computer readable medium, such as a memory, magnetic disc or optical disc, and used to control a processor to manage interaction with a user. The declarative interaction specification from which the Statechart is derived may be read from in a computer readable medium, or received as an input data stream.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for generating an extended Harel Statechart for an automated interaction from a declarative interaction specification that comprises a model of interaction data and a set of controls, the method comprising:
generating a set of states in the extended Harel Statechart corresponding to the set of controls of the interaction specification;
generating a data model in the extended Harel Statechart from the model of interaction data, the data model being associated with the set of states; and
generating a self-transition to each state of the set of states of the extended Harel Statechart, wherein the self-transitions include actions associated with the state.

2. A method in accordance with claim 1, wherein the actions associated with a state comprise:
an action for generating an event to indicate that a part of the data model associated with this state has changed; and
an action for generating an event to update the data model after a user input event.

3. A method in accordance with claim 1, wherein a control of the set of controls comprises:
a control type; and
at least one variable.

4. A method in accordance with claim 1, wherein the declarative interaction specification further comprises an interaction policy and wherein generating a set of states in a Harel Statechart comprises:
partitioning the set of states of the extended Harel Statechart into at least one set of sub-states in accordance with the interaction policy; and
for each set of sub-states, generating a single parallel state in the extended Harel Statechart containing all members of the sub-state parallel sub-states.

5. A method in accordance with claim 4, further comprising generating transitions between states in the extended Harel Statechart in accordance with the policy.

6. A method in accordance with claim 5, wherein the transitions between states include actions for generating an activation change event.

7. A method in accordance with claim 1, wherein the declarative interaction specification further comprises model item properties associated with items of the model of interaction data, the method further comprising:
generating a set of data model actions from the model item properties of declarative interaction specification, the data model actions to be evaluated when the data model is updated.

8. A method in accordance with claim 7, wherein the model item properties include model item properties that constrain items of the model of interaction data.

9. A method in accordance with claim 7, wherein the model item properties include item properties that specify automatic updates of fields of the model of interaction data based on of other fields the model of interaction data.

10. A method in accordance with claim 1, wherein the declarative interaction specification further comprises model item properties and wherein the controls and model item properties are related to the model by the use of binding expressions.

11. A method in accordance with claim 1, wherein the declarative interaction specification comprises an Xforms specification.

12. A computer readable medium containing programming instructions that, when executed on a processor, control the processor to perform the method of claim 1.

13. A computer readable medium containing programming instructions that, when executed on a processor, control the processor to generate an extended Harel Statechart for an automated interaction from a declarative interaction specification that comprises a model of interaction data and a set of controls, the programming instructions comprising:
a MAP-CONTROLS function operable to generate a set of states in the extended Harel Statechart corresponding to the set of controls of the interaction specification, and further operable to generate self transitions to each state of the set of states of the extended Harel Statechart, wherein the self-transitions include actions associated with the state;
a MAP-MODEL function, operable to generate a data model in the extended Harel Statechart from the model of interaction data, the data model being associated with the set of states; and
a MAP-ACTIVATION function, operable to generate transitions between sets of states in the Harel Statechart, such transitions being associated with controls being activated at the same time, and further operable to generate exit and entry conditions on the combined states and actions associated with the transitions.

14. A computer readable medium in accordance with claim 13, wherein the declarative interaction specification further comprises properties and wherein the programming instructions further comprise:
a MAP-PROPERTIES function operable to generate a set of data model actions from the properties of declarative interaction specification, the data model actions to be evaluated when the data model is updated.

15. A computer readable medium in accordance with claim 14, wherein attributes of a property of the declarative interaction specification, including a binding expression, are transferred to a corresponding data model action as a set of variables associated with the data model action.

16. A system for generating an extended Harel Statechart for an automated interaction, the system comprising:
an input for receiving a declarative interaction specification comprising a model of interaction data and a set of controls;
a means for generating a set of states in the extended Harel Statechart corresponding to the set of controls of the interaction specification;
a means for generating a data model in the extended Harel Statechart from the model of interaction data, the data model being associated with the set of states;
a means for generating a self-transition to each state of the set of states of the extended Harel Statechart, wherein the self-transitions include actions associated with the state;
a means for generating transitions between states, the transitions corresponding to control activation; and
a means for outputting the extended Harel Statechart.

17. A method in accordance with claim 16, wherein the declarative interaction specification comprises an Xforms specification.
